(19) United States
(12) Patent Application Publication
(10) Pub. No.: US 2008/0062250 A1
(43) Pub. Date: Mar. 13, 2008

(54) PANORAMIC WORLDVIEW NETWORK CAMERA WITH INSTANT REPLY AND SNAPSHOT OF PAST EVENTS

(75) Inventors: David J. Rye, Kent, WA (US); James R. Phillips, Bellevue, WA (US); Leslie A. Leech, Kowloon (HK); George E. Stevenson, Kowloon (HK)

Correspondence Address: BLACK LOWE & GRAHAM, PLLC, 701 FIFTH AVENUE, SUITE 4800, SEATTLE, WA, 98104, US

(73) Assignee: X10 Wireless Technologies, Inc., Kent, WA (US)

(21) Appl. No.: 11/832,561

(22) Filed: Aug. 1, 2007

Related U.S. Application Data
(60) Provisional application No. 60/825,502, filed on Sep. 13, 2006.

(51) Int. Cl. H04N 7/14; H04N 7/00

(52) U.S. Cl. 348/14.01; 348/36; 348/E07.001; 348/E07.077

(57) ABSTRACT

Image viewing system and method for use with a video telephony application. The method includes forming a panoramic image by moving the camera about at least one axis, capturing images from at least two different camera positions, and joining the images together. The method also includes presenting the panoramic image on a visual display device, receiving input from a user indicating that a subset of the panoramic image has been selected, pointing the camera in a direction corresponding to the selected subset, and presenting images from the camera corresponding to the selected subset on the visual display device. The system includes a camera with a controllable pivot assembly that pivots in at least one direction in signal communication with a computer, and a software module that directs the pivot assembly to move the camera and presents images on a display.

### PRIORITY CLAIM

This invention claims priority from U.S. Provisional Application Ser. No. 60/825,502, entitled “NETWORK CAMERA,” filed Sep. 13, 2006.

### FIELD OF THE INVENTION

This invention relates generally to video telephony and, more specifically, to systems and methods for viewing images with a video telephony system.

### BACKGROUND OF THE INVENTION

There are several ways to make an Internet Protocol (IP) phone call or otherwise communicate over a network, such as the Internet, using an IP telephony application or service. Generally, a user may connect a microphone and speakers to a personal computer (PC) in order to communicate with a person at another location. Several of these services also support video so that a networked camera (web cam) may be connected to the PC allowing the performance of “Video Telephony.” However, these systems tend to be limited to showing a field of view restricted to that available to the webeam at a given moment, and also tend not to allow pan, tilt, and zoom capability for the webcam. This is disadvantageous because it does not provide a larger context for the currently displayed image and does not allow adjustments to be easily made to the webcam's positioning or zoom level by referring to an image that extends beyond that currently within the webcam's field of view. Accordingly, there is a need for a greater field of view to be presented when using video telephony.

### SUMMARY OF THE INVENTION

The present invention comprises a method for using and manipulating video images. In one example, it includes a method or system for forming a panoramic image by moving a camera about at least one axis, capturing images from at least two different camera positions, and joining the images together. The method also includes presenting the panoramic image on a visual display device, receiving input from a user indicating that a subset of the panoramic image has been selected, pointing the camera in a direction corresponding to the selected subset, and presenting images from the camera corresponding to the selected subset on the visual display device.

In accordance with further examples of the invention, forming a panoramic image includes panning and tilting the camera such that the resulting joined panoramic image is both horizontally and vertically panoramic. In some examples of the invention, a selection box overlay is presented over the panoramic image on the visual display device. The selection box is movable by a user, and receiving input includes receiving information corresponding to the selection box location in relation to the panoramic image.

In accordance with additional examples of the invention, the camera may be controlled by a remote user over a computer network, and the resulting images are viewed remotely.

In accordance with still further examples of the invention, the invention comprises an image viewing system for use with a video telephony application, local and remote displays associated with local and remote computers in communication over a network, each of the local and remote computers having a processor, a memory in data communication with the processor, a user input device, and at least one input/output port. The system comprises a camera including a controllable pivot assembly that pivots in at least one direction in signal communication with the computer; a local software module for storage on and operable by the local computer that directs the pivot assembly to move the camera, captures images from at least two different camera positions, joins the captured images into a panoramic image, sends the panoramic image to the remote computer, receives input from a remote user indicating that a subset of the panoramic image has been selected, directs the pivot assembly to point the camera in a direction corresponding to the selected subset, and sends images from the camera corresponding to the selected subset to the remote computer; and a remote software module for storage on and operable by the remote computer that displays a user interface on the remote display, accepts input from the remote user, sends the input to the local computer, and presents the panoramic image and the selected subset of the panoramic image on the remote display.

In accordance with yet other examples of the invention, the pivot assembly pivots in at least two directions such that the camera can be panned horizontally and tilted vertically. Additionally, the local software module directs the pivot assembly to pan and tilt the camera and joins the captured images into a panoramic image that is both horizontally and vertically panoramic.

In accordance with additional examples of the invention, images from the camera may be stored on a hard drive or other non-volatile storage medium associated with the computer of a local or a remote user. The stored images may be replayed, even while current images continue to be stored. A user viewing the stored images may listen to previously recorded audio corresponding to the recorded video, conduct a voice conversation with another user over the network while watching the recorded video, or both listen to the recorded audio and conduct a live voice conversation at the same time. A user viewing the stored images may also take a snapshot of the video, which is stored as a digital photograph. In similar fashion, snapshots may also be taken while viewing current video images.

### BRIEF DESCRIPTION OF THE DRAWINGS

Preferred and alternative embodiments of the present invention are described in detail below with reference to the following drawings:

FIGS. 1 and 2 are diagrams showing an example environment of an embodiment of the invention;

FIG. 3 is a perspective view of a camera used in an embodiment of the invention;

FIG. 4 is an exploded perspective view of a camera, a mount, and a knurled mounting screw;

FIG. 5 is a representation of the way images are displayed in an embodiment of the invention;

FIGS. 6 through 10 are diagrams showing user interface windows used in an embodiment of the invention;

FIG. 11 is a diagram of a wireless remote control device used in an embodiment of the invention; and

FIGS. 12 and 13 are flowcharts for a method of displaying images in accordance with an embodiment of the invention.

### DETAILED DESCRIPTION OF THE PREFERRED EMBODIMENT

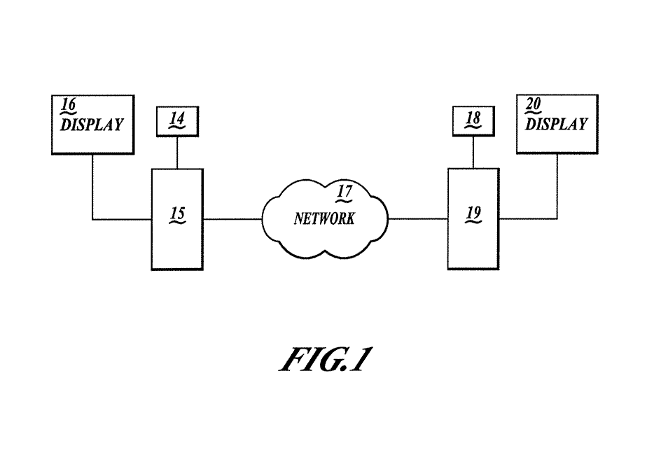

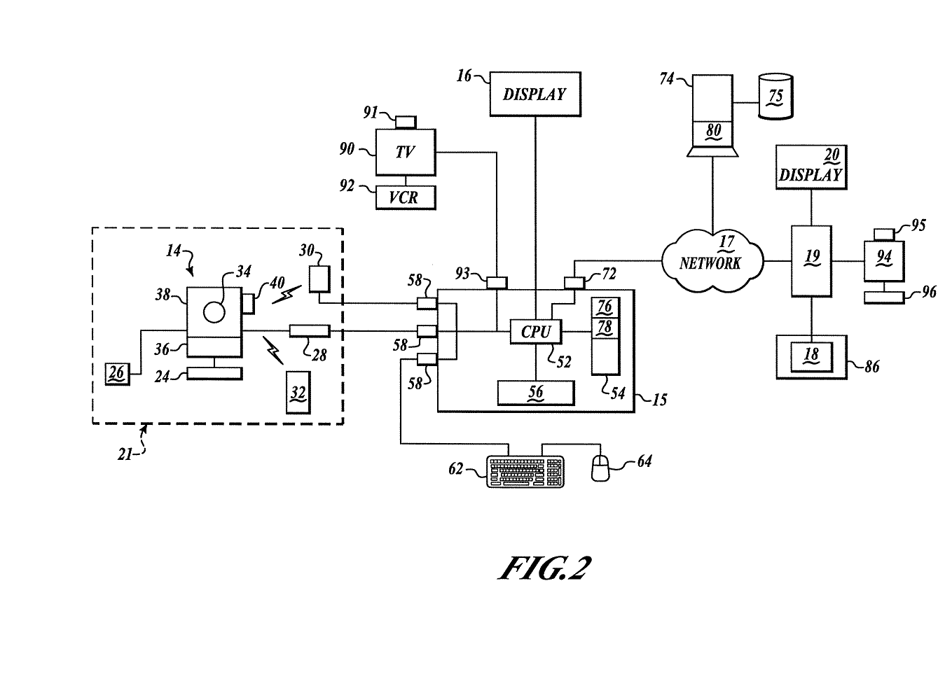

FIGS. 1 and 2 are diagrams showing an example environment of an embodiment of the invention. FIG. 1 shows a first camera 14 at a first location in signal communication with a first computer 15 that is connected to a first display 16. The computer 15 is connected to a public or private network 17 such as the Internet, for example. An optional second camera 18 at a second location is in signal communication with a second computer 19 that is also connected to the network 17. A second display 20 is connected to the second computer 19. The cameras 14, 18 may be directed to take panoramic scans for display on the displays 16, 20. The panoramic scans may also be stored on either or both of the computers 15, 19. A first user at the first location and a second user at the second location are able to view scans from the camera 14, 18 associated with their location, the camera 14, 18 associated with the other user's location, or both. Additionally, each user is able to select a subset of either panoramic image so that current video corresponding to the selected subset will be displayed on their display 16, 20. The selected video feed may also be stored on their computer 15, 19 for later viewing, or so that they may ‘rewind’ or jump to any location within the stored video feed while current video is still being stored. The first and second users are also able to have voice communications during viewing of the stored video. They are able to conduct live voice communications, even while viewing recorded video. Audio synched to the video feed may also be recorded if desired. The first and second users, locations, computers (15, 19), cameras (14, 18), and displays (16, 20) also may be referred to as a local or primary user, location, computer 15, camera 14, and display 16 and a remote or secondary user, location, computer 19, camera 18, and display 20 respectively.

With reference to FIG. 2, an example system 21, formed in accordance with an embodiment of the invention, includes the camera 14, a mount 24, a power supply 26, a video capture device 28, a wireless transceiver 30, and a remote 32. The camera 14 is shown connected to the video capture device 28 and the power supply 26. In a preferred embodiment, the camera 14 is a CCD camera with pan, tilt, and zoom capability, such as the Vanguard Camera (model XC21A) from X10 Wireless Technology, Inc., for example. The camera 14 is also wirelessly remotely controllable. However, in other embodiments, the camera 14 may be controlled by being directly connected by wire or other means to a controlling device rather than being wirelessly controllable. The camera 14 includes a lens 34, a base 36, a pivot assembly 38 that allows for pan and tilt capability of the lens 34 relative to the base 36, and a transceiver 40 for receiving commands. The pivot assembly 38 is controllable by signals received at the transceiver 40. Movement is achieved by servos (not shown) or other devices enabling the field of view to be adjusted. The camera 14 is attached to the mount 24 that allows the camera 14 to be attached to a desired location such as a wall, a ledge, a ceiling, or another desired location. However, in other embodiments, the camera 14 may be directly attached to a desired surface, or in some cases simply rested upon a desired surface.

The video capture device 28 is in signal communication with the camera 14, and is connected to the computer 15. An example video capture device 28 is model VA11A from X10 Wireless Technology, Inc. The video capture device 28 is in data communication with the computer 15, and translates video information from an output associated with the camera 14 into a form more suitable for further processing by the computer 15. The computer 15 includes a processor 52 in data communication with a memory 54, a hard drive 56, and a plurality of USB ports 58. However, in other embodiments, the computer 15 may use other types of nonvolatile memory other than or in addition to the hard drive 56, and may have other types of input/output ports. The display 16, a keyboard 62, and a mouse 64 are also in signal communication with the computer 15.

The computer 15 is in signal communication with the network 17 using a network interface 72. In an example embodiment, the signal communication is conducted over a wired link. However, wireless links are used in other embodiments. A server 74 is also connected to the network 17. The system 21 also includes system software components 76 and hardware drivers 78 that are installed on the computer 15 and, in an example embodiment reside in the memory unit 54 when the system is being operated. The server 74 is in data communication with a database 75 and includes updates 80 that may be downloaded by a user of the system 21 and installed on the computer 15. Alternatively, the server 74 may automatically send the updates 80 to the computer 15. The software components 76 integrate seamlessly with an IP telephony application the user prefers. Example compatible IP telephony applications include Skype, Yahoo Messenger with Voice, MSN Live Messenger, and America Online Instant Messenger (AIM).

Other computers, such as the second computer 19 shown connected to the second display 20, are also connected to the network 17. The second computer 19 is also in signal communication with a second system 86, including the second camera 18, that is preferably (but not necessarily) configured similarly to the system 21. This allows a first user operating a video telephony application on the computer 15 to communicate with a second user operating a video telephony application on the second computer 19 by using the system 21 and the second system 86 to present images on the display 16 and the second display 20.

A first television (TV) 90 and a first video cassette recorder (VCR) 92 are also shown in FIG. 2 because the camera 14 optionally has the ability to transmit a video signal wirelessly for display on the TV 90 via a wireless video receiver 91 connected to a video input of the TV 90. Additionally, video feeds from the camera 14 may be recorded on the VCR 92 if desired. The computer 15 is in signal communication with the TV 90 using a video out port 93 in signal communication with the processor 52. The computer 15 may send video images from either the camera 14 or the camera 18 to the TV 90. The VCR 92 may record these video images through its connection to the TV 90, or alternatively may be directly connected to the video out port 93 rather than the TV 90. In similar fashion, a second TV 94 may wirelessly receive video from the camera 18 via a second wireless receiver 95. The computer 19 is in signal communication with the TV 94 and may send video images from either the camera 14 or the camera 18 to the TV 94. A second VCR 96 is in signal communication with the TV 95 and may be used similarly to the first VCR 92. Rather than using the first VCR 92 and the second VCR 96, other video recording devices such as digital video disk recorders or hard drive based digital video recorders may also be used.

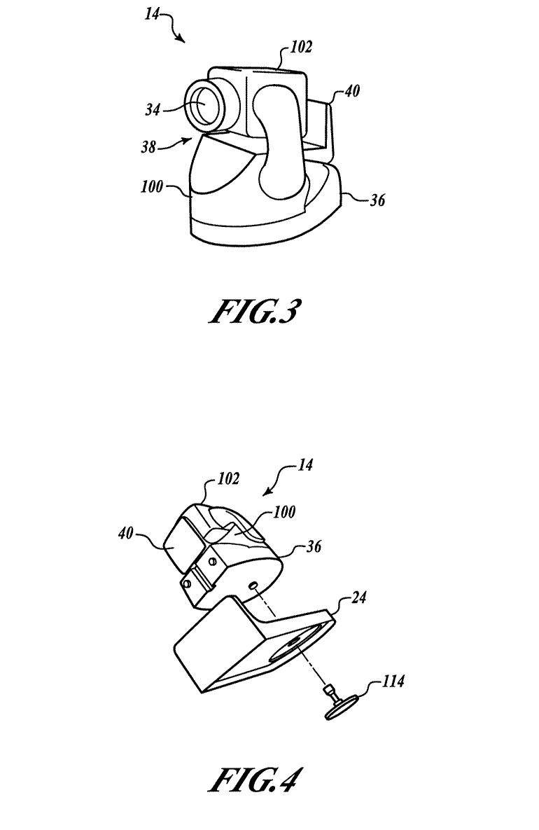

FIG. 3 shows a perspective view of the camera 14 used in an embodiment of the invention. The camera 14 includes the base 36 and the pivot assembly 38. The pivot assembly 38 includes a middle member 100 rotatably attached to the base 24, and an upper member 102 pivotably attached to the middle member 100. When the camera 14 is mounted on a horizontal surface, the lens 34 of the camera 14 may be panned by rotating the middle member 100 relative to the base 36. In similar fashion, the lens 34 of the camera 14 may be tilted by pivoting the upper member 102 with respect to the middle member 100. In the example shown, the camera lens 34 is included within the upper member 102. However, in other embodiments, the camera lens 34 and/or camera electronics (not shown) may be a separate assembly that is attached to the upper member 102. Other methods of panning, tilting, or otherwise changing the field of view of the camera 14 may also be used.

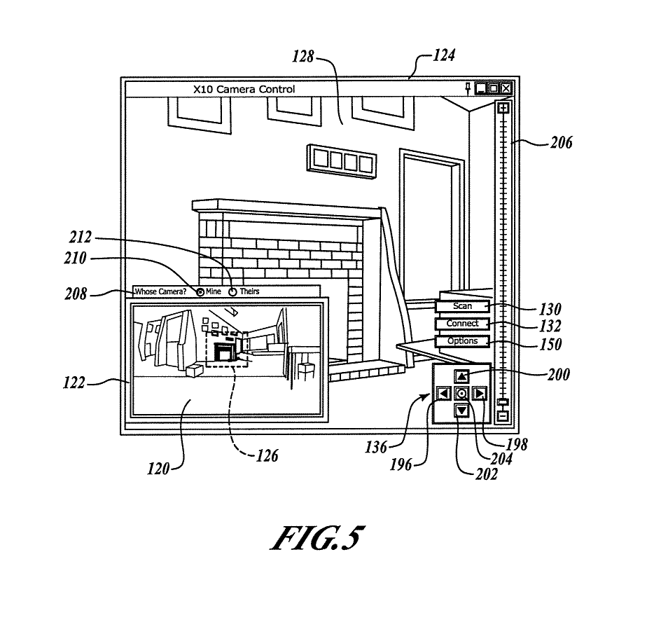

FIG. 4 shows an exploded perspective view of the camera 14, the mount 24, and a knurled mounting screw 114 used to attach the camera 14 to the mount 24. The mount 24 includes a plurality of mounting holes that allow it to be fixedly attached in a desired location such as on a wall, a ledge, a ceiling, or another location using mounting screws (not shown).

FIGS. 5 through 10 show a representation of the way images are presented on displays 16, 20 in an embodiment of the invention as well as various user interface buttons and windows used to control the cameras 14, 18 and manipulate their images. With respect to FIG. 5, a panoramic image 120 appears in a window 122 located in a lower left hand corner of a main window 124. Although the window 122 is shown in the lower left hand corner of the main window 124, the window 122 may be repositioned to other locations of the main window 124, or may be closed or hidden from view if desired in an example embodiment. A moveable, resizable overlay box 126 is shown near the center of the panoramic image 120. The size and location of the overlay box 126 indicates a selected subset of the panoramic image 120 that appears as a selected image 128 shown in the main window 124. A number of virtual interface buttons also appear over the selected image 128. A scan button 130, a connect button 132, and an options button 134 are shown over a directional control interface 136.

Software stored on one or both of the computers 15, 19 causes the buttons 130, 132, 134 and other control features to be displayed as part of a user interface. A mouse associated with the computer 15, 19 causes a cursor to move on the display 16, 20 as desired by a user. When the cursor is over a desired user interface button 130, 132, 134 or other control feature, a mouse button can be clicked by the user, which activates the indicated user interface button 130, 132, 134 or other control feature by indicating to the software stored on the computer 15, 19 of the desired action. The software then directs the processor associated with the computer 15, 19 to take the appropriate action, which may include making adjustments to either the camera 14, 18 locally associated with the computer 15, 19 or to the camera associated with the other computer by sending commands over the network 17.

The scan button 130, when clicked with a mouse or other pointing device, initiates a scan to capture a panoramic image. At any time during a video conference, a user may initiate a scan. In an example embodiment, a three pass scan is conducted, with each pass spanning the horizontal range of the camera 14, 18, but being positioned at differing adjacent vertical levels. Alternatively, the scans may be positioned at slightly overlapping vertical levels. The images produced by the three passes are then joined to form a single panoramic image. A user may then right-click in the main window 124 and select a “save Minimap” option to save the panoramic scan to their computer.

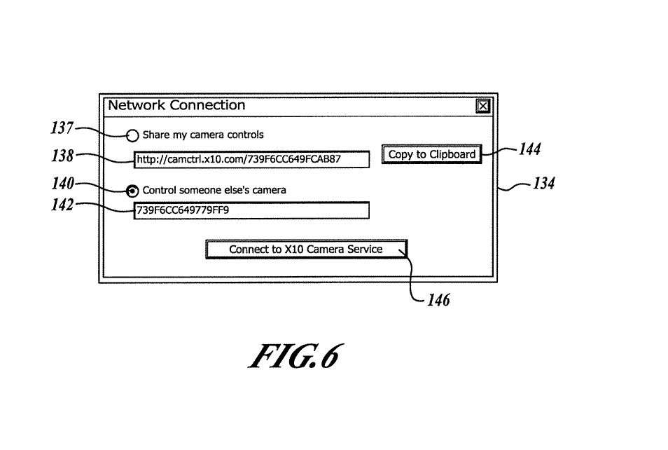

The connect button 132, when clicked with a mouse or other pointing device, causes a network connection window 134 to appear, shown in FIG. 6. The network connection window 134 includes a ‘share my camera controls’ radio button 137 with a corresponding first text entry area 138 as well as a ‘control someone else's camera’ radio button 140 with a corresponding second text entry area 142. A uniform resource locator (URL) is displayed in the first text entry area 138, which includes a current session code that may be sent from a first user to a second user so that they can control the first user's camera remotely. An example URL that may be displayed is http://camctrl.x10.com/739F6CC649FCAB87. In this example, the last portion of the URL is the session code, which in this case is 739F6CC649FCAB87. A ‘copy to clipboard’ button 144 also appears in the network connection window 134 that, when pressed, copies the session code to the clipboard associated with the computer's operating system so that the session code may be pasted into an email or instant messaging chat box, for example, to be sent to another user.

If the first user clicks the ‘share my camera controls’ radio button 137 and sends the displayed session code to the second user, the second user may then paste the session code into the second text box 142 and activate the ‘control someone else's camera’ radio button 140 if they have the software installed on their computer. Alternatively, if the second user does not have the software installed on their computer, they may paste the entire URL into a browser. This will give them an Active X control applet that behaves in a similar manner to the software application, and that they can use to control the first user's camera. A ‘connect to X10 camera service’ button 146 is also displayed in the network connection window 134 that is clicked after the second user pastes the session code into the second text entry area 142. After doing so, the second user is then able to control the first user's camera and see images captured by it. In like fashion, the first user can follow the same steps to obtain control of the second user's camera if they have one. In an example embodiment, the session code expires when the user whose camera is being controlled logs off. The next time the user connects, a new session code is sent in order to share their camera controls.

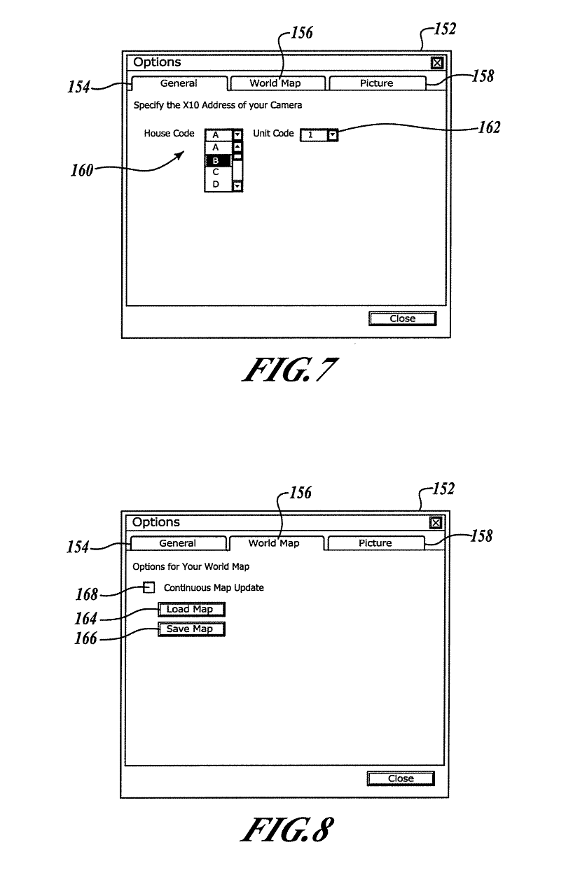

The options button 150, when clicked with a mouse or initiated by another input device, causes an options window 152 to be displayed as shown in FIGS. 7 through 10. In an example embodiment, the options window 152 contains a general tab 154, a worldmap tab 156, and a picture tab 158 at the top. As a default when the options window 152 first appears, or if the general tab 154 is clicked at a later time, a house code selector 160 and a unit code selector 162 are displayed so that the proper camera may be selected. The camera 14 is set with a default setting of ‘A’ for the house code and ‘1’ for the unit code. However, if multiple cameras are used at a given location, they may be distinguished from each other by setting each to have a different code combination.

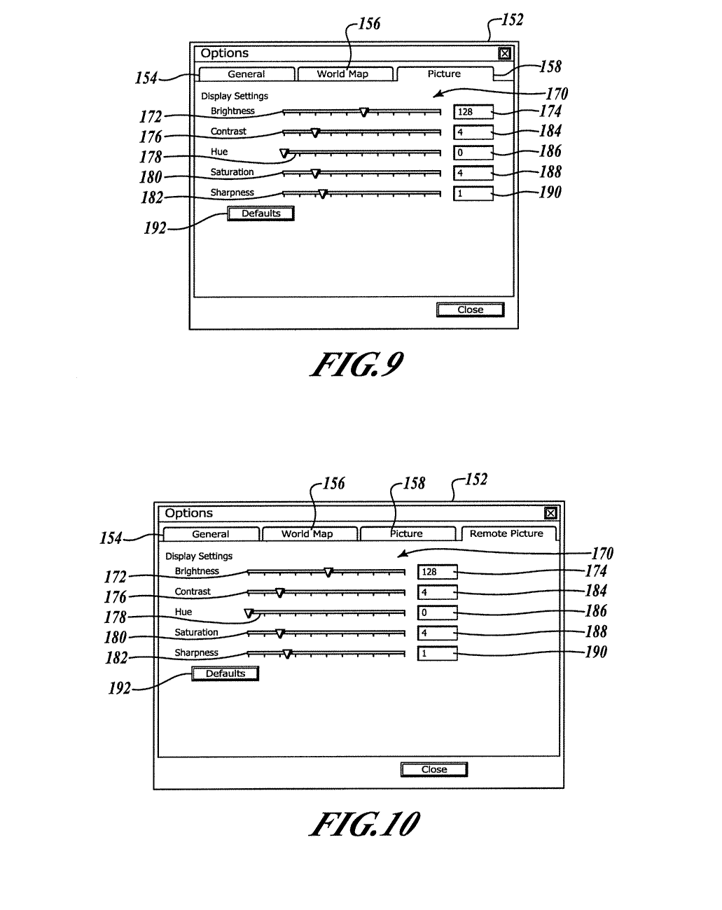

If the world map tab 156 is clicked, a ‘load map’ button 164, a ‘save map’ button 166, and a ‘continuous map update’ selector box 168 are displayed as shown in FIG. 8. Clicking on the ‘load map’ button 164 allows a previous panoramic image scan to be loaded by selecting it using a file dialog box (not shown). Clicking on the ‘save map’ button 166 allows a currently displayed panoramic image to be saved to a file. Marking the ‘continuous map update’ selector box 168 causes the panoramic image to be continuously updated. In an example embodiment, a camera with two imaging components is used so that the panoramic image is updated by the first imaging component while live video of a subset of the panoramic image is recorded by the second imaging component. Alternatively, two cameras rather than a single camera with two imaging components may be used. In another example embodiment having only a singe camera with one imaging component, selecting continuous map update will allow the panoramic image to be continuously updated without continuous live video being concurrently displayed of a subset of the panoramic image.

If the picture tab 158 is clicked, a series of video image controls 170 are displayed as shown in FIG. 9. In an example embodiment, the controls 170 include a brightness slide control 172 and corresponding numeric text entry control 174, either of which may be used to adjust the brightness and automatically cause the other control to be correspondingly updated. In addition, contrast, hue, saturation, and sharpness slide controls 176, 178, 180, and 182 respectively and corresponding numeric entry controls 184, 186, 188, and 190 respectively are also present in the example embodiment. A defaults button 192 is also displayed that sets all of the display settings to their default values when clicked.

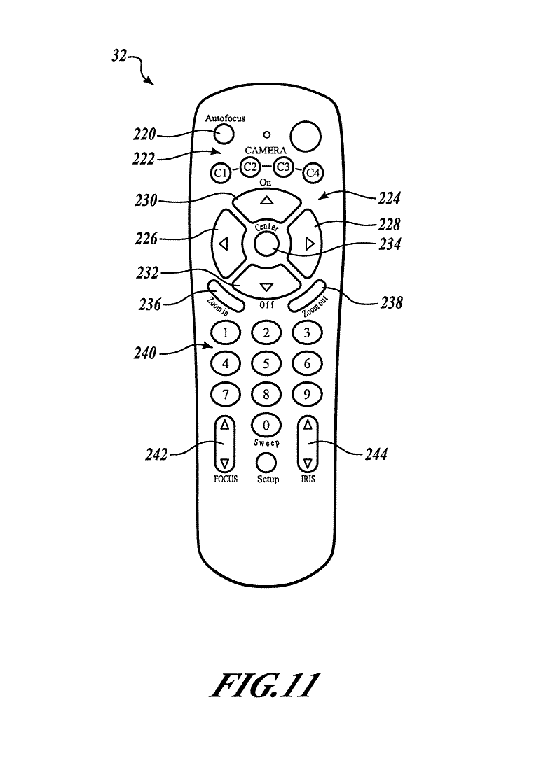

In addition to the tabs 154, 156, 158 described above, a remote picture tab 194 is also displayed when two computers have been connected together on-line as shown in FIG. 10. Clicking on the remote picture tab 194 causes the same video image controls 170 to appear as for the picture tab 158, but rather than controlling the user's own video image, they control the image being received from the other user.

The directional control interface 136 shown in FIG. 5 includes a left arrow button 196 and a light arrow button 198 that are used to pan the camera 14, 18. The directional interface 136 also includes an up arrow button 200 and a down arrow button 202 that are used to tilt the camera 14, 18. In addition, a centering button 204 may be used to center the camera 14, 18 within its potential field of view. A zoom-level slide control 206 may be used to zoom in and out on the image 120, and also visually shows the selected level of zoom. Additionally, in an example embodiment, the overlay box 126 is also resized to correspond to the zoom level selected by the slide control 206. In addition to controlling the zoom level with the slide control 206, a user may also control the zoom level by resizing the overlay box 126. This may be performed by selecting a corner of the box 126 with a cursor controlled by a mouse, clicking, and dragging the corner toward or away from the center of the box 126, for example. These actions that affect zoom level are interpreted by software stored on the computer 15, 19 corresponding to the display 16, 20 of the user performing the zoom. The software then causes the appropriate visual information to be sent to the relevant display 16, 20 to show the selected zoom level.

A camera selector bar 208 allows a user to select whether they wish to display images produced by their own camera by clicking a first radio button 210 designated ‘Mine’ or that of another user that they are in communication with using a video telephony application by clicking a second radio button 212 designated ‘Theirs’. In this embodiment, both the panoramic image 120 and the selected image 128 will correspond to the selected camera. However, in other embodiments, images from both a local and a remote camera 14, 18 may be presented on the display simultaneously such as with additional image windows, for example.

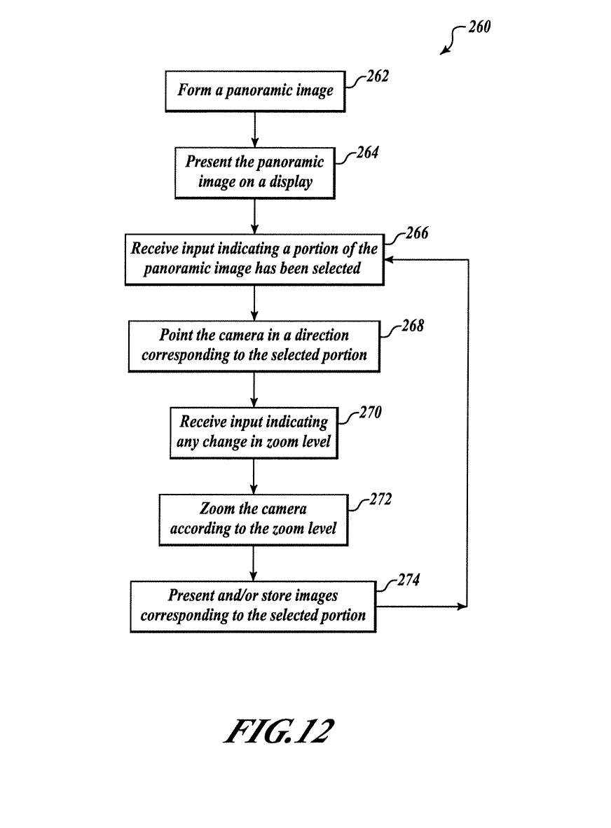

FIG. 11 shows a more detailed diagram of the wireless remote control device 32 in accordance with an embodiment of the invention. The remote 32 includes an autofocus button 220 and a plurality of camera selection buttons 222 designated as C1, C2, C3, and C4. The remote 32 also includes a remote directional control interface 224 that corresponds to the virtual directional control interface 136 described for FIG. 5. The directional interface 224 includes a left arrow button 226 and a right arrow button 228 that are used to pan the camera 14. The directional interface 224 also includes an up arrow button 230 and a down arrow button 232 for tilting the camera 14 as well as a centering button 234 used to center the camera 14 within its potential field of view. The remote 32 also includes a zoom in button 236 and a zoom out button 238. Additionally, the remote 32 includes a set of numeric buttons 240, a focus rocker button 242 used to manually adjust the focus of the camera 14, and an iris rocker button 244 used to manually adjust an iris setting of the camera 14.

When a user presses buttons on the remote 32, it sends wireless signals to the camera 14, 18 which receives the signals at the transceiver 40 and takes the appropriate action corresponding to the pressed button. In an example embodiment, the wireless signals are radiofrequency (RF) signals. However, in other embodiments, the signals may be infrared (IR) or other types of wireless signals. Also, in some embodiments, the remote 32 sends signals to the computer 15, 19 rather than directly to the camera 14, 18. The computer 15, 19 then interprets the signals and sends appropriate commands to the cameras 14, 18.

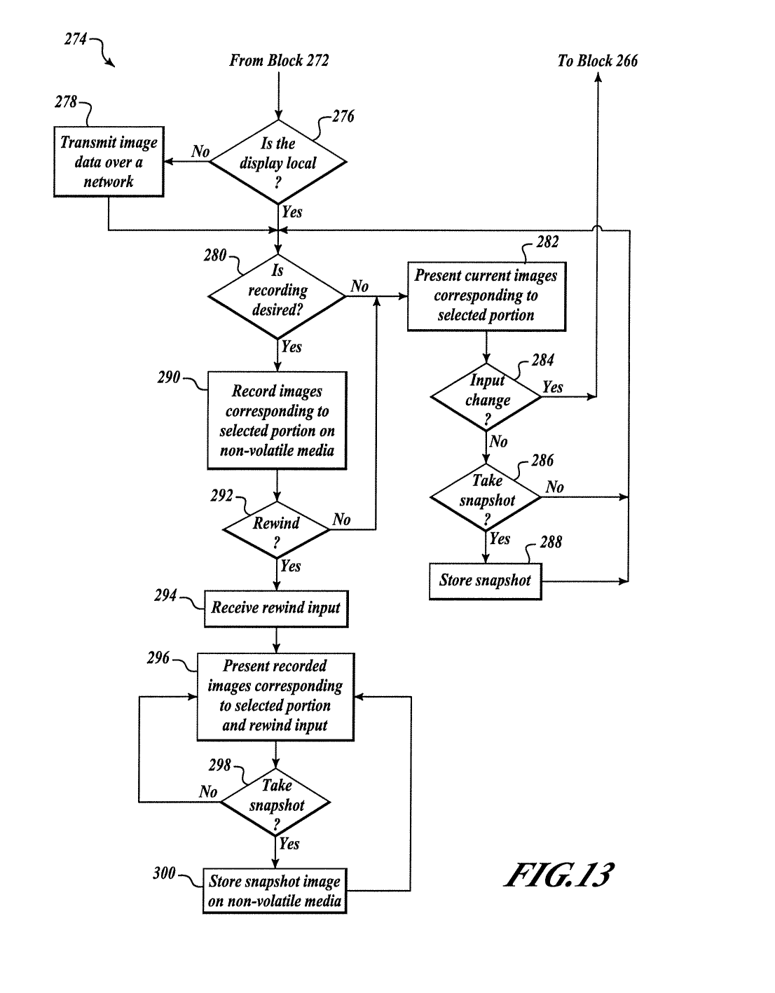

FIGS. 12 and 13 are flowcharts for a method 260 of displaying images in accordance with an embodiment of the invention. The method 260 begins at a block 262 where a panoramic image is formed. In a preferred embodiment, the panoramic image is formed by panning and tilting the camera, capturing images from a plurality of camera positions, and joining the images together such that the resulting panoramic image is both horizontally and vertically panoramic. In an example embodiment, three horizontal scans across the entire field of view of the camera are taken by panning the camera, then tilting the camera between scans so that each scan shows a different portion of the vertical field of view of the camera. Then, the three scans are joined to form a single panoramic image. In an example embodiment, this process occurs automatically when the application is started. The process can also be initiated by clicking the scan button 130 as described with respect to FIG. 5. After the panoramic image has been created, it is stored (in a preferred embodiment) and will not be updated unless the scan button 130 is pressed or the user has marked the continuous map update box 168 as described with respect to FIG. 8. A user may capture and store an image of an entire parking lot, an entire back yard and swimming pool, or an entire living room area, for example.

Next, at a block 264, the panoramic image is presented on the visual display device 16. Alternatively, or in addition, the panoramic image is sent over the network 17 and presented on the remote visual display device 20 associated with a remote user with whom the primary user is communicating. Then, at a block 266, input is received from a user indicating that a subset of the panoramic image has been selected. In a preferred embodiment, the movable, resizable selection box 126 overlay is first presented over the panoramic image on the visual display 16. This allows a user to indicate a selected subset of the panoramic image by moving and/or resizing the selection box 126. This may be performed by selecting a corner of the box 126 with a cursor controlled by a mouse, clicking, and dragging the corner toward or away from the center of the box 126 for example. These actions that affect the selected subset of the panoramic image are interpreted by software stored on the computer 15, 19 corresponding to the display 16, 20 of the user performing the selection. The software then causes the appropriate visual information to be sent to the relevant display 16, 20 to show the selected subset of the panoramic image.

After a subset of the panoramic image has been selected, the camera is pointed in a direction corresponding to the selected subset at a block 268. Next, at a block 270, input is received indicating any change in zoom level. This may be received from a user operating the zoom-level slide control 206 and/or the zoom in button 236 and zoom out button 238. Next, at a block 272, the camera is zoomed according to the zoom input. Then, at a block 274, images corresponding to the selected subset are presented and/or stored. This allows the user to see current images from the selected subset while still seeing the entire panoramic image, such as by using multiple windows as described with respect to FIG. 4. Following the block 274, the method 260 returns to the block 266.

FIG. 13 shows a more detailed flowchart for the block 274. First, at a decision block 276, it is determined whether the display is a local display. If the display is not local, image data corresponding to the panoramic image and/or the selected subset is transmitted over a network at a block 278. Then, at a decision block 280, it is determined whether recording of the selected image is desired. If the display was determined to be local at the decision block 276, the method also proceeds to the decision block 280. If recording is not desired, images corresponding to the selected portion are presented at a block 282. Then, at a decision block 284, it is determined whether there is a change in input such as a movement or resizing of the overlay box, activation of one or more directional buttons, or a change in zoom level. If there is a change in input, the method returns to the block 266. If there is not a change in input, the method 260 proceeds to a decision block 286 where it is determined whether the user desires to take a snapshot of the image being presented. In an example embodiment, this is performed by displaying a user interface button overlay on the presented image that when clicked causes software stored on the user's computer to store a digital image of the scene currently being displayed. If a snapshot is desired as indicated by a mouse click on the user interface button, a snapshot is stored at a block 288 on non-volatile media such as the hard drive 56, for example. Then, the method 260 returns to the decision block 280. If a snapshot was not desired at the decision block 286, the method 260 also returns to the decision block 280.

If recording is determined to be desired at the decision block 280, images corresponding to the selected subset are recorded on non-volatile media such as the hard drive 56 at a block 290. In some versions of the invention, all images from the camera are automatically captured and stored in a computer memory in a fashion that enables playback while further recording takes place. Then, at a decision block 292, it is determined whether the user wishes to rewind. This may be performed using a user interface slide control on a display, for example. If the user does not wish to rewind, the method 260 proceeds to the block 282. If the user does wish to rewind, rewind input is received at a block 294 indicating how far the user wishes to rewind. Then, at a block 296, recorded images corresponding to the selected portion and the rewind input are presented. Next, at a decision block 298, it is determined whether the user wishes to take a snapshot. If a snapshot is desired, a snapshot image is stored on non-volatile media such as the hard drive 56, for example. Then, the method 260 returns to the block 296. If a snapshot is not desired at the decision block 298, the method 260 also returns to the block 296. In an example embodiment, when recorded images are being displayed at the block 296, the user has the option of hearing recorded audio, maintaining live voice communications with a remote user, or listening to both recorded audio and maintaining live voice communications. These options could be presented to the user as user interface buttons on their display, for example. When clicked, the software residing on the user's computer would direct the appropriate audio information to be played or streamed.

Although shown in a particular sequential order, various steps of the method 260 may be performed concurrently, or in a different order. Also, in some embodiments, fewer or greater numbers of steps may be performed by the system 21, 86. It should be appreciated, for example, that the ability to replay, rewind, or jump to any location within a stored image can take place at any time during or after the image is recorded. Likewise, the ability to view previously recorded images and capture single frames for use as snapshots can take place at any time, whether during or after the video conference.

In accordance with the stored images function, a member of a teleconference who may have missed a portion of a conversation or otherwise wants to replay a portion of the conversation can simply rewind (or jump to) the portion of the conference he would like to replay. While watching the replay, the system continues to record the live portion of the conference and allows the user to rejoin the live portion at any time. Likewise, the user can revisit a previously recorded video portion of the conference while participating in a live audio portion of the conference. This combination facilitates a much more productive telephone conference over that available with current technologies.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A method of viewing images over a network comprising:
forming a panoramic image from a first camera, the first camera being in signal communication with a first computer operable by a first user, the first computer having a first storage device and a first display;
sending the panoramic image over the network from the first computer to a second computer operable by a second user;
storing the panoramic image on a second storage device associated with the second computer; and
displaying the panoramic image and a subset of the panoramic image on a second display in signal communication with the second computer.

2. The method of claim 1, wherein forming a panoramic image includes panning and tilting the first camera such that the resulting panoramic image is both horizontally and vertically panoramic.

3. The method of claim 1, further comprising:
receiving input from either the first user or the second user selecting a different subset of the panoramic image;
pointing the first camera in a direction corresponding to the different selected subset; and
presenting images from the first camera corresponding to the different selected subset on at least one of the first display or the second display.

4. The method of claim 3 further comprising:
presenting a selection box overlay over the panoramic image, wherein the selection box is selectively movable; and
receiving input from either the first user or the second user indicating a location for the selection box in relation to the panoramic image.

5. The method of claim 3, wherein the panoramic image and the different selected subset are displayed simultaneously.

6. The method of claim 3, further comprising receiving input by the second user at the second computer to cause the first camera to create an updated panoramic image from the first camera and to send the updated panoramic image to the second computer.

7. The method of claim 3, further comprising receiving input by the first user at the first computer to cause the first camera to create an updated panoramic image from the first camera and to send the updated panoramic image to the second computer.

8. The method of claim 1, further comprising:
receiving a zoom input from the second user; and
zooming the first camera according to the zoom input.

9. The method of claim 1, wherein the step of forming a panoramic image further comprises capturing images from the first camera and a second camera in signal communication with the first computer and joining the images to form the panoramic image.

10. The method of claim 1, further comprising:
transmitting image data over the network using a voice over internet protocol software component.

11. The method of claim 10, wherein the software component includes one of Skype, MSN Live, Yahoo Messenger, or AOL Messenger.

12. The method of claim 3, further comprising recording the images from the first camera corresponding to the selected subset on the second storage medium associated with the second computer.

13. The method of claim 12, further comprising:
receiving input from the second user directing the second computer to display a recorded image;
presenting the recorded image on the second display; and
continuing to record current images from the first camera on the second storage device while viewing the recorded image on the second display.

14. The method of claim 13, further comprising:
receiving input from the second user directing the second computer to store a snapshot of a recorded image; and
storing the snapshot.

15. The method of claim 1, further comprising:
receiving input from the first user directing the first computer to store a snapshot of a recorded image; and
storing the snapshot.

16. An image viewing system for use with a video telephony application, local and remote displays associated with local and remote computers in communication over a network, each of the local and remote computers having a processor, a memory in data communication with the processor, a user input device, and at least one input/output port, the system comprising:
a camera including a controllable pivot assembly that pivots in at least one direction in signal communication with the local computer;
a local software module for storage on and operable by the local computer that directs the pivot assembly to move the camera, captures images from at least two different camera positions to form a panoramic image, joins the captured images into a panoramic image, sends the panoramic image to the remote computer, receives input from a remote user indicating that a subset of the panoramic image has been selected, directs the pivot assembly to point the camera in a direction corresponding to the selected subset, and sends images from the camera corresponding to the selected subset to the remote computer; and
a remote software module for storage on and operable by the remote computer that displays a user interface on the remote display, accepts input from the remote user, sends the input to the local computer, and presents the panoramic image and the selected subset of the panoramic image on the remote display.

17. The system of claim 16, wherein the pivot assembly pivots in at least two directions such that the camera can be panned horizontally and tilted vertically, and wherein the local software module is configured to direct the pivot assembly to pan and tilt the camera and join the captured images into a panoramic image that is both horizontally and vertically panoramic.

18. The system of claim 16, wherein the software module is configured to present a selection box overlay on the displayed panoramic image and wherein the software module is configured to receive input from the remote user allowing the selection box to be moved in relation to the panoramic image and the location of the selection box indicates the selected subset of the panoramic image.

19. The system of claim 16, wherein the software module is further configured to receive a zoom input from the remote user and direct the camera to be zoomed according to the zoom input.

20. The system of claim 16, wherein the software module is configured to cause the panoramic image to continue to be displayed on a portion of the remote display while the images corresponding to the selected subset are being displayed.

21. The system of claim 16, wherein the remote software module is further configured to store the received selected subset of the panoramic image on a non-volatile storage medium associated with the remote computer.
